(19) United States
(12) Patent Application Publication
(10) Pub. No.: US 2017/0280130 A1
(43) Pub. Date: Sep. 28, 2017

(54) 2D VIDEO ANALYSIS FOR 3D MODELING

(71) Applicant: Microsoft Technology Licensing, LLC, Redmond, WA (US)

(72) Inventor: Nicholas David Burton, Derby (GB)

(73) Assignee: Microsoft Technology Licensing, LLC, Redmond, WA (US)

(21) Appl. No.: 15/344,478

(22) Filed: Nov. 4, 2016

Related U.S. Application Data
(60) Provisional application No. 62/313,617, filed on Mar. 25, 2016.

(51) Int. Cl. H04N 13/02; G06T 17/00; H04N 5/91; G06T 7/00; H04N 13/00; G06K 9/00

(52) U.S. Cl. CPC H04N 13/026; H04N 13/0011; H04N 13/004; H04N 13/0059; G06K 9/00744; H04N 5/91; G06T 7/0022; G06T 17/00; G06T 2207/10004; G06T 2207/10021

(57) ABSTRACT

A method includes receiving a two-dimensional (2D) video of a physical scene, the 2D video including a plurality of 2D image frames, for each of a plurality of candidate 2D image frames of the 2D video, computer testing the candidate 2D image frame using at least one of a feature count criteria, a pose criteria, and an image quality criteria, computer validating selected ones of the plurality of candidate 2D image frames that satisfy the feature count criteria, the pose criteria, and the image quality criteria, and providing a set of validated 2D image frames to a three-dimensional (3D) reconstruction system to generate a 3D model of at least a portion of the physical scene.

### CROSS REFERENCE TO RELATED APPLICATIONS

This application claims priority to U.S. Provisional Patent Application No. 62/313,617, filed Mar. 25, 2016, the entirety of which is hereby incorporated herein by reference.

### BACKGROUND

Multiple two-dimensional (2D) images (e.g., video) of a physical scene may be used to generate a three-dimensional (3D) model of the physical scene or one or more objects within the scene. For example, the 3D model may be a surface or volumetric reconstruction of the physical scene.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A method includes receiving a two-dimensional (2D) video of a physical scene, the 2D video including a plurality of 2D image frames, for each of a plurality of candidate 2D image frames of the 2D video, computer testing the candidate 2D image frame using at least one of a feature count criteria, a pose criteria, and an image quality criteria, computer validating selected ones of the plurality of candidate 2D image frames that satisfy the feature count criteria, the pose criteria, and the image quality criteria, and providing a set of validated 2D image frames to a three-dimensional (3D) reconstruction system to generate a 3D model of at least a portion of the physical scene.

### BRIEF DESCRIPTION OF THE DRAWINGS

FIG. 1 shows a mobile computing device including a camera capturing a two-dimensional (2D) video of a physical scene that may be used to generate a three-dimensional (3D) model of the physical scene.

FIG. 2 shows a block diagram of an example use environment for automatically selecting a set of 2D image frames of a 2D video for generating a 3D model.

FIG. 3 shows a method of using a computer to automatically select a set of 2D image frames of a 2D video for generating a 3D model.

FIG. 4 shows a multi-pass method of using a computer to automatically select a set of 2D image frames of a 2D video for generating a 3D model.

FIG. 5 shows an example computing system.

### DETAILED DESCRIPTION

Manually reviewing a two-dimensional (2D) video on a frame-by-frame basis in order to select a particular set of 2D image frames from which to generate a three-dimensional (3D) model, via a photogrammetric approach, for example, would be an incredibly time-consuming endeavor for a user. Furthermore, a user may not be skilled enough to recognize which frames are suitable for generating a 3D model. For example, a user attempting to generate a 3D model from a 2D video may not know which 2D image frames include a suitable number and/or type of features needed to generate a high-quality 3D model. Further, the user may not be able to manually determine the photographic quality (e.g., level of blur) of the 2D image frame corresponding to each perspective.

The present disclosure is directed to various computer-automated approaches for intelligently selecting a set of 2D image frames from a 2D video of a physical scene to generate a high-quality 3D model of the physical scene without user intervention. Various 2D image frames of the 2D video may be computer analyzed to determine whether the 2D image frame provides suitable information and has sufficient photographic quality to define the physical scene in the 3D model. For example, each candidate 2D image frame may be computer tested using selection criteria based on a pose of the candidate 2D image frame, a number of features included in the 2D image frame, and a photographic quality score of the 2D image frame. Such testing may produce a set of validated 2D image frames that satisfy the selection criteria and thus have sufficient information to reconstruct the physical scene in the 3D model.

By intelligently selecting the set of 2D image frames in an automated manner, a 3D model may be generated from any suitable 2D video without user intervention. For example, such automation may allow a 3D model to be generated via a background process such that a 3D model can be reconstructed from a 2D video as the 2D video is being acquired by a computing device. Moreover, such automation may allow the 3D modeling process to be offloaded to a remote computing device. Accordingly, local computing resources of a computing device that acquired the 2D video may be made available for other computing operations. In some implementations, the automation 2D image frame selection process may be performed by a service computing device that is further configured to generate 3D models from a plurality of different 2D videos provided by a plurality of different computing devices. For example, a cloud-based video storage device may automatically generate 3D models from 2D video uploaded to the cloud-based video storage device.

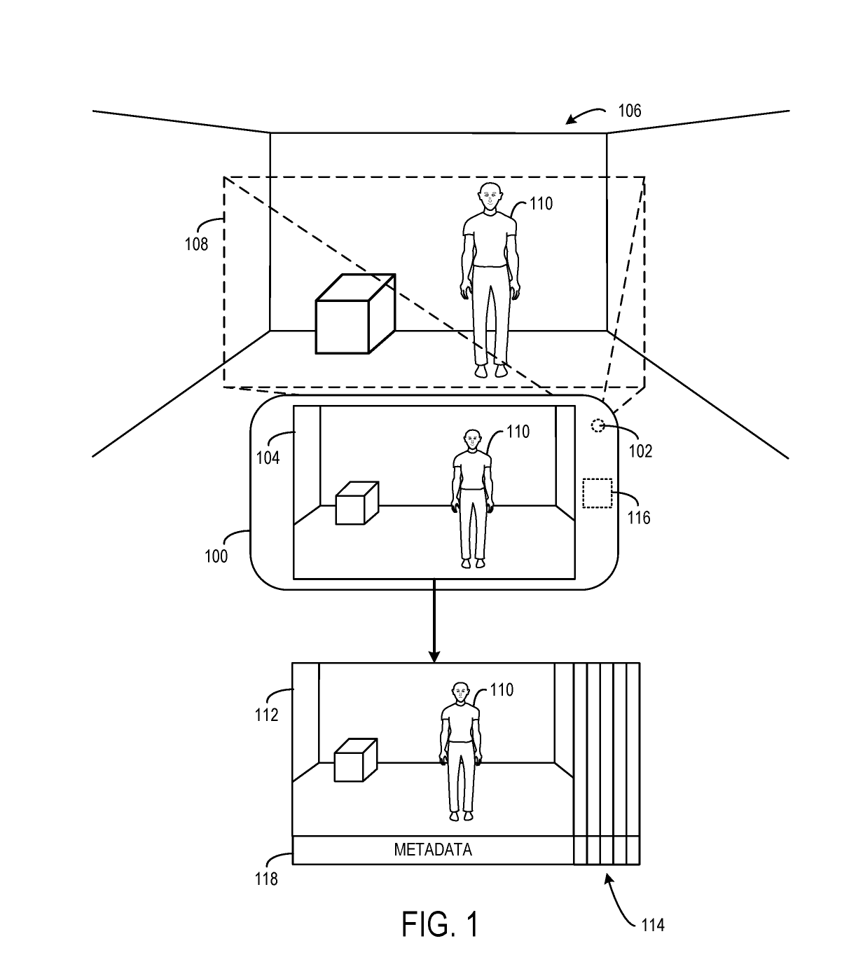

FIG. 1 shows a mobile computing device 100 including an outward-facing point-of-view camera 102 and a display 104. The point-of-view camera 102 images a physical scene 106 within a field of view 108. The physical scene 106 includes real-world objects, such as a person 110. The physical scene 106 can be captured in a two-dimensional (2D) video 112 by the camera 102. The 2D video 112 includes a sequence of 2D image frames 114. In some implementations, each 2D image frame includes a plurality of pixels, and each pixel is defined with one or more values corresponding to one or more different parameters (e.g., a red value, a blue value, and a green value for an RGB color 2D image frame; and/or an infrared value for an IR image frame). Each value may be saved as a binary number, and the size of the binary number determines the bit depth of the 2D image frame. The number of pixels defines the resolution of the 2D image frame. This disclosure is compatible with virtually any type of 2D image frames (e.g., RGB, IR, grayscale), any hit depth, and/or any resolution.

Furthermore, the mobile computing device 100 may include a pose sensing system or position-sensing componentry 116 usable to determine the position and orientation of the mobile computing device 100 in an appropriate frame of reference. In some implementations, the position-sensing componentry 116 returns a six degrees-of-freedom (6DOF) estimate of the three Cartesian coordinates of the mobile computing device 100 plus a rotation about each of the three Cartesian axes. To this end, the position-sensing componentry may include any, some, or each of an accelerometer, gyroscope, magnetometer, and global-positioning system (GPS) receiver. The output of the position-sensing componentry 116 may be associated with the 2D video 112 as metadata 118. In one example, each 2D image frame may include metadata indicating a pose of the mobile computing device 100 in the physical scene 106 when the 2D image frame was captured by the camera 102. In another example, the 2D video 112 may include various key frames dispersed among the sequence of 2D image frames 114. Each key frame may include metadata indicating a pose, and each 2D image frame neighboring the key frame (e.g., in between the current key frame and the next key frame) may be associated with the pose of the key frame or interpolated from the frame of surrounding key frames.

Once the 2D video 112 has been captured. the 2D video 112 may be consumed in any suitable manner. For example, the 2D video 112 may be visually presented via the display 104, stored in a storage machine of the mobile computing device 100 for later playback, and/or sent to a remote computing device via a computer interface of the mobile computing device 100.

Furthermore, as discussed herein, candidate 2D image frames may be intelligently selected from the plurality of image frames 114 of the 2D video 112 based on selection criteria including a feature count criteria, a pose criteria, and an image quality criteria. A set of 2D image frames that is validated as meeting such criteria may be used to generate a three-dimensional (3D) model of the physical scene 106 and/or objects within the physical scene 106, such as the person 110.

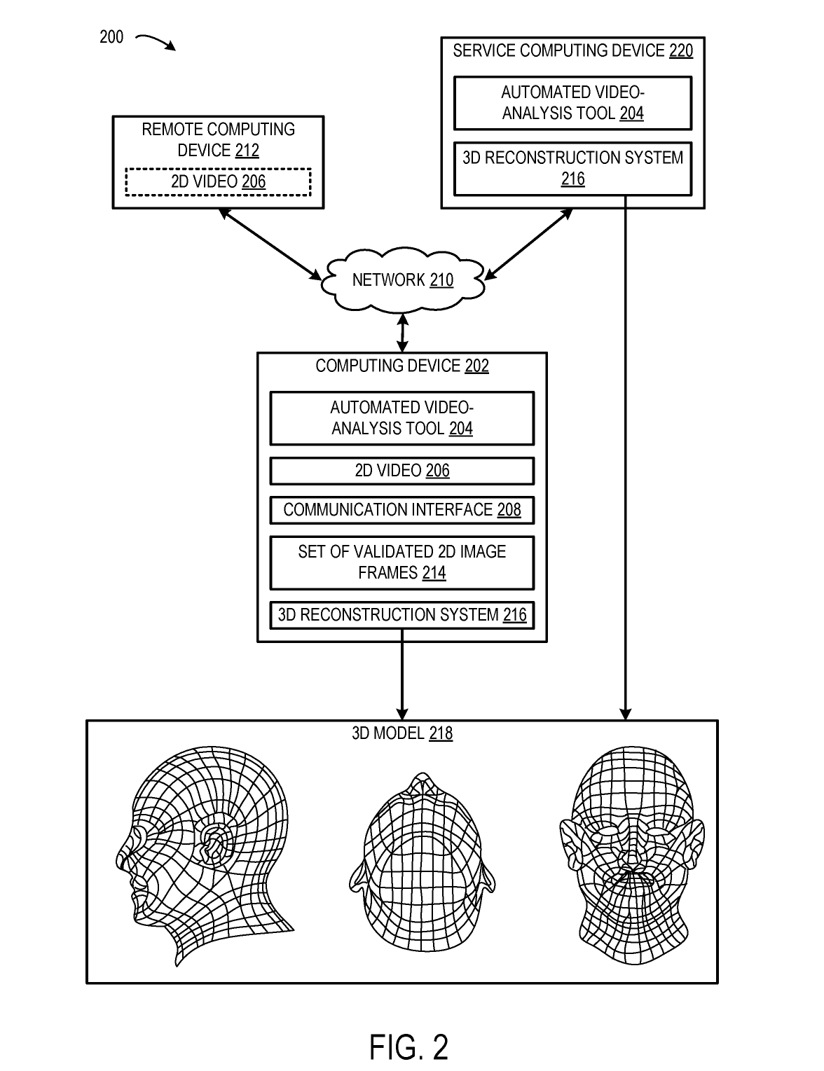

FIG. 2 shows a block diagram of an example use environment 200 in which a set of validated 2D image frames can be automatically and intelligently selected from a 2D video in order to generate a 3D model. In particular, a computing device 202 may include an automated video-analysis tool 204. The computing device 202 is a non-limiting example of mobile computing device 100 of FIG. 1. The automated 2D video-analysis tool 204 may be configured to receive a 2D video 206.

The 2D video may be received by the computing device 202 in any suitable manner. In one example, the computing device 202 may include an on-board camera configured to capture the 2D video 206. In another example, the automated video-analysis tool 204 may retrieve the 2D video 206 from on-board memory of the computing device 202. In yet another example, the computing device 202 may include a communication interface 208 that enables communication over a network 210 with a remote computing device 212. The computing device 202 may receive the 2D video 206 from the remote computing device 212 via the communication interface 208. In one scenario, the remote computing device 212 “live” streams the 2D video 206 to the computing device 202 as the remote computing device 212 is capturing the 2D video 206. In another scenario, the 2D video 206 may be previously recorded by the remote computing device 212 or another computing device, and sent to the computing device 202, via the communication interface 208.

The communication interface 208 may include any suitable wired and/or wireless communication hardware. In one example, the communication interface 208 includes a personal area network transceiver (e.g., a Bluetooth transceiver). In another example, the communication interface 208 includes a local area, network transceiver (e.g., a Wi-Fi transceiver). The communication interface 208 may employ any suitable type and/or number of different communication protocols to communicate with any suitable remote computing device.

The automated video-analysis tool 204 may be configured to analyze candidate 2D image frames of the 2D video 206 based on selection criteria to intelligently select a set 214 of validated 2D image frames that can be used to generate a 3D model. A candidate 2D image frame is a 2D image frame of the 2D video 206 that is selected by the automated video-analysis tool 204 for testing. In particular, the automated video-analysis tool 204 may be configured to use at least one of a feature count criteria, a pose criteria, and an image quality criteria to computer test each of a plurality of candidate 2D image frames of the 2D video 206 for inclusion in the set 214 of validated 2D image frames. The automated video-analysis tool 204 may test any suitable number of 2D image frames of the 2D video for inclusion in the set 214 of validated 2D image frames, Further, the automated video-analysis tool 204 validates selected ones of the plurality of candidate 2D image frames that satisfy the feature count criteria, the pose criteria, and the image quality criteria for inclusion in the set 214 of validated 2D image frames. Candidate 2D image frames that fail to meet any of the feature count criteria, the pose criteria, and the image quality criteria are not validated and not selected for inclusion in the set 214 by the automated video-analysis tool 204.

The feature count criteria, pose criteria, and image quality criteria are provided as non-limiting examples of selection criteria that may be used by the automated video-testing tool 204 to computer test the candidate 2D image frames for inclusion in the set 214 of validated 2D image frames. The automated video-analysis tool 204 may use any suitable testing criteria, procedure, and/or approach to computer test the candidate 2D image frames for inclusion in the set 214 of validated 2D image frames. Moreover, the automated video-analysis tool 204 may modularly cooperate with other testing components to carry out the computer testing using the selection criteria. For example, the automated video-analysis tool 204 may employ plug-ins, standalone applications, complementary modules, third-party services, etc. to analyze the candidate 2D image frames and perform testing using the different selection criteria. In one example, the automated video-analysis tool 204 may employ a separate module configured to perform a separate test for each of the feature count criteria, pose criteria, and image quality criteria. Note that the present disclosure is not directed to the creation of new testing procedures, but instead takes advantage of state of the art testing procedures to convert 2D video into 3D models.

The automated video-analysis tool 204 may test the candidate 2D image frames using any suitable computer analysis, including supervised and unsupervised machine learning algorithms and/or techniques. Example machine-learning algorithms and/or techniques include, but are not limited to, exploratory factor analysis, multiple correlation analysis, support vector machine, random forest, gradient boosting, decision trees, boosted decision trees, generalized linear models, partial least square classification or regression, branch-and-bound algorithms, neural network models, deep neural networks, convolutional deep neural networks, deep belief networks, and recurrent neural networks. Such machine-learning algorithms and/or techniques may, for example, be trained to assess features of the candidate 2D image frames. It is to be understood that any of the computer-implemented determinations described herein may leverage any suitable machine-learning approach, or any other computer-executed process for intelligently selecting a set of 2D image frames for generating a 3D model.

The automated video-analysis tool 204 may be configured to determine the set 214 of validated 2D image frames from the 2D video 206 at any suitable time. In some cases, the automated video-analysis tool 204 may determine the set 214 as the 2D video 206 is being captured by an on-board camera. In other cases, the automated video-analysis tool 204 may determine the set 214 from the 2D video 206 at a time subsequent to being captured or received by the computing device 202. For example, the automated video-analysis tool 204 may retrieve the 2D video 206 from local storage to determine the set 214.

In some implementations, the automated video-analysis tool 204 may be configured to refine the initial set 214 of validated 2D image frames by performing additional processing of the 2D video 206 to select additional and/or alternative validated 2D image frames from the 2D video for inclusion in the set 214. The automated video-analysis tool 204 may analyze 2D image frames that neighbor the validated 2D image frames in the 2D video. For example, the automated video-analysis tool 204 may select additional/alternative 2D image frames based on those 2D image frames satisfying one or more of the feature count criteria, the pose criteria, and the image quality criteria better than validated 2D image frames previously selected for inclusion in the set 214.

Once the automated video-analysis tool 204 has determined and/or refined the set 214 of validated 2D image frames, the automated video-analysis tool 204 may submit the set 214 to a 3D reconstruction system 216 to generate a 3D model 218. The 3D reconstruction system 216 may generate the 3D model 318 from the set 214 of validated 2D image frames in any suitable manner. The 3D model 218 may include any suitable portion of a physical scene that is captured by the 2D video 206. In the illustrated example, the 3D model 218 is a surface reconstruction model of the head of a person, such as the person 110 of the 2D video 112 of FIG. 1.

The automated video-analysis tool 204 may send the set 214 of validated 2D image frames to any suitable type of 3D reconstruction system to generate the 3D model. Note that the present disclosure is not directed to the creation of new 3D modeling procedures, but instead is directed to automated and intelligent selection of 2D image frames from which a 3D model can be created.

In some implementations, automated video analysis and/or refinement of the 2D video 206 may be performed by a cloud or service computing device, such as service computing device 220. In the illustrated example, the service computing device 220 includes the automated video-analysis tool 204 and the 3D reconstruction system 216. In other examples, the service computing device 220 includes only the automated-video-analysis tool 204. In other examples, the service computing device 220 includes only the 3D reconstruction system 216. Moreover, the service computing device 220 may be configured to perform automated video analysis and corresponding 3D modeling for 2D videos received from a plurality of different remote computing devices, such as the computing device 202 and the remote computing device 212.

Furthermore, the service computing device 220 may be configured to selectively perform additional analysis and/or refinement of a set of validated 2D image frames based on a processing load of the service computing device 220. For example, the service computing device 220 may be configured to determine if processing resources are available for refining a set of 2D image frames of a 2D video. If the processing resources are available, then the service computing device 220 may refine the set of 2D image frames. If the processing resources are not available, then the service computing device 220 may generate the 3D model via the 3D reconstruction system 216 based on the unrefined set 214.

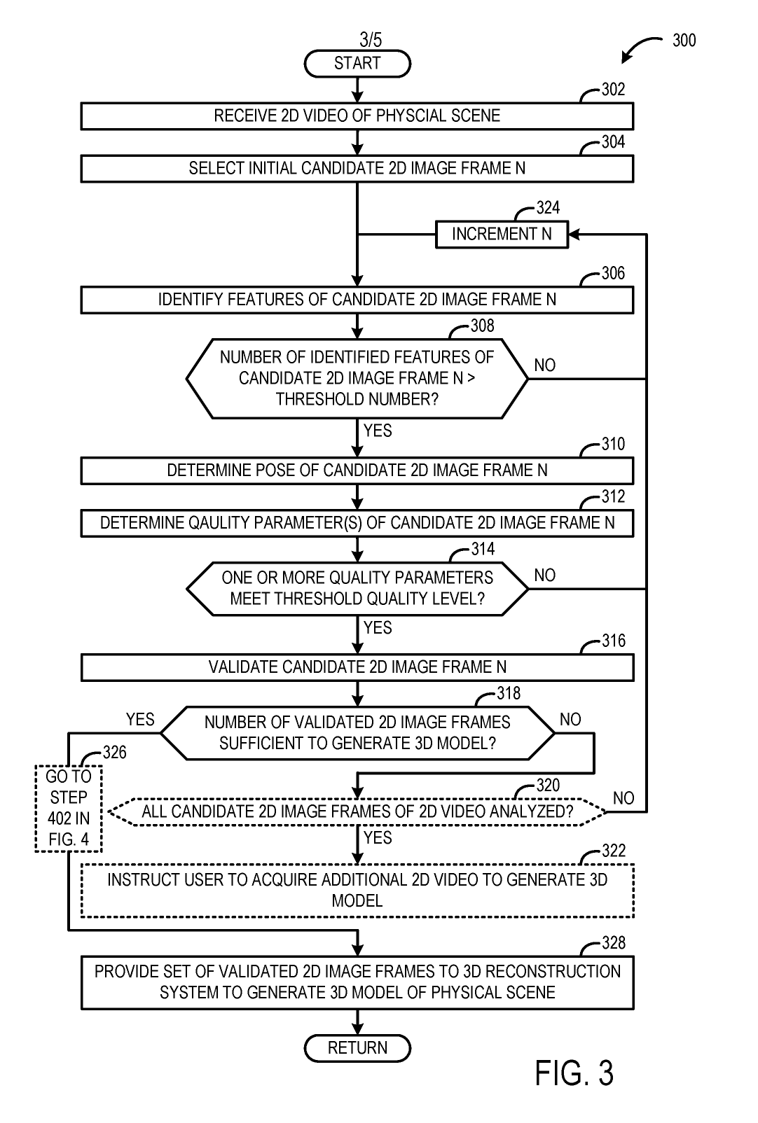

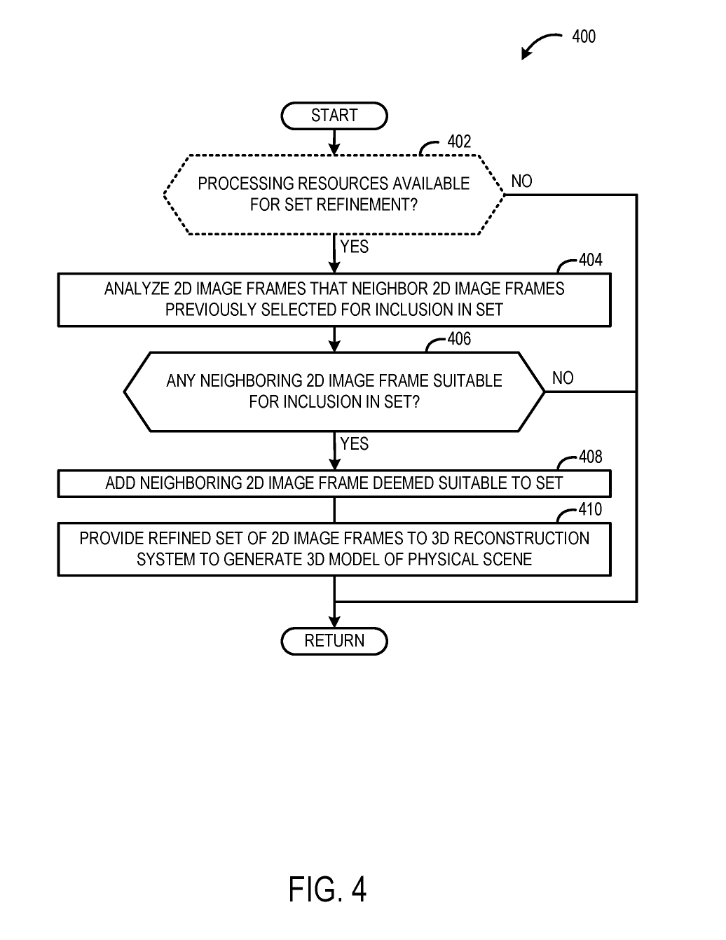

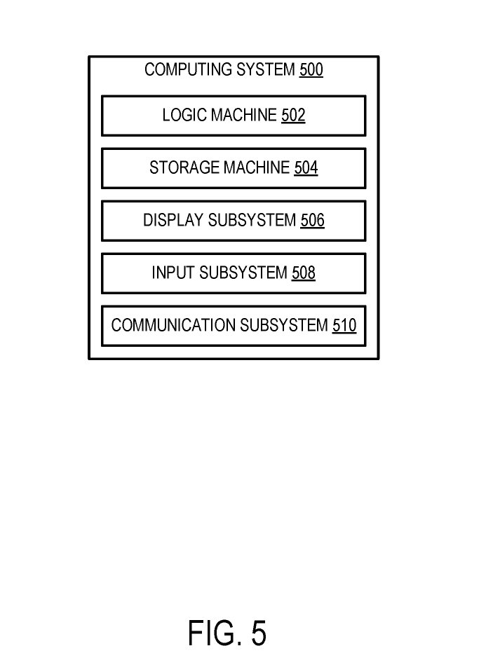

Examples of testing and validation of candidate 2D image frames of a 2D video for 3D modeling are discussed in further detail below with reference to FIGS. 3 and 4. FIG. 3 shows an example method 300 for intelligently selecting a set of 2D image frames of a 2D video to use as a basis for generating a 3D model. For example, the method 300 may be performed by a computing device, such as the mobile computing device 100 of FIG. 1, the computing device 202 of FIG. 2, or a computing system 500 of FIG. 5.

At 302, the method 300 includes receiving a 2D video of a physical scene. The 2D video includes a sequence of 2D image frames. In some implementations, the 2D video may be received in real-time by the computing device. In one example, the computing device is a smartphone including a camera that captures “live” 2D video. In another example, the 2D video is a 2D video stream received from a remote computing device, such as a 2D video stream received during a video chat. In some implementations, the 2D video may be previously recorded. In one example, the previously-recorded 2D video is retrieved from a local storage machine of the computing device, in another example, the previously-recorded 2D video is received from a remote computing device, such as a cloud computing device.

In some implementations, the 2D video may include supplemental metadata that defines various characteristics of the 2D video and/or the content (e.g., the physical scene) of the 2D video. For example, such metadata may include parameters measured by sensors of the computing device or sensors of a computing device that generated the 2D video. Non-limiting examples of such parameters may include a position and/or orientation measured by an inertial measurement unit (IMU), a distance relative to an object in the scene measured by a range finder, and a GPS location provided by a GPS sensor. Other metadata may include timestamps, descriptive tags, contextual tags, video format, and other information.

At 304, the method 300 includes selecting an initial candidate 2D image frame N from the 2D video. The initial candidate 2D image frame N may be selected in any suitable manner. In one example, the initial candidate 2D image frame N is the first 2D image frame of the 2D video. In another example, the initial candidate 2D image frame N is positioned a time (e.g., 3 second) or a set number of frames (e.g., 30 frames) after the start of the 2D video. In another example, the initial candidate 2D image frame N is the first frame with reliable pose metadata (e.g., from an IMU and/or GPS).

At 306, the method 300 includes identifying features of the candidate 2D image frame N. Features may be specific structures in the candidate 2D image frame N, such as points, edges, boundaries, curves, blobs, and objects. The features of the candidate 2D image frame N may be identified according to any suitable feature detection algorithm or processing operation. Non-limiting examples of feature detectors that may be employed to identify the features of the candidate 2D image frame N include: Canny, Sobel, Kayyali, Harris & Stephens/Plessey, Smallest Univalue Segment Assimilating Nucleus (SUSAN), Shi & Tomasi, Level Curve Curvature, Features from Accelerated Segment Test (FAST), Laplacian of Gaussian, Difference of Gaussians, Determinant of Hessian, Maximally Stable Extremal Regions (MSER), Principal curvature-based region detector (PCBR), and Grey-level blobs. Any suitable combination of feature detectors may be employed to identify different features of the candidate 2D image frame.

Such features may be determined based on computer analysis of the pixels of the candidate 2D image frame, using one or more of the machine-learning algorithms described above or any other suitable approach. Any suitable features of the candidate 2D image frame may be computer analyzed or otherwise processed as part of the testing procedure to validate the candidate 2D image frame.

At 308, the method 300 includes determining whether a number of identified features of the candidate 2D image frame N is greater than a threshold number of features. The threshold number of features may indicate a minimum number of features that makes the candidate 2D image frame N useful for defining features of the physical scene in the 3D model. By checking for a minimum number of features in a candidate 2D image frame, subsequent processing operations may be selectively performed on candidate 2D image frames that are deemed to be useful for generating the 3D model. The threshold number of features may be set to any suitable number. Different types of features may be given different weightings. If the number of features in the candidate 2D image frame N is greater than the threshold number of features, then the method 300 moves to 110. Otherwise, the candidate 2D image frame is deemed unsuitable for 3D model generation, and the method 300 moves to 324.

At 310, the method 300 includes determining a pose of the candidate 2D image frame N. The pose may include a position and/or orientation of a camera that acquired the 2D image frame N when the 2D image frame was acquired. The pose of the camera may be determined in any suitable manner. In one example, the pose is determined based on pose data and/or image data of the 2D video. For example, optical flow and/or other video analysis may be used to assess pose from 2D video. As another example, the pose data may be measured by the IMU, magnetometer, GPS, and/or other sensors of the computing device that acquired the candidate 2D image frame N. In another example, IMU outputs and visual tracking are combined with sensor fusion to determine the pose of the candidate image frame. The pose data may be tested against pose criteria that indicates whether the pose data accurately represents the pose of the capture device in the physical space. In one example, the pose criteria is used to test whether the pose sensors are providing reliable sensor data by comparing the sensor data to a pose reliability threshold (e.g., a moving average of the sensor output). In one example, if the output of the pose sensor corresponding to the candidate 2D image frame is infinite or is an error indication, then the pose data for the candidate 2D image frame is considered unreliable and does not satisfy the pose criteria.

The pose data may be used by one or more of the machine-learning algorithms discussed above and/or any other suitable approach to determine whether the pose data accurately represents the pose of the 2D image frame. Any suitable aspects of the pose data may be computer analyzed or otherwise processed as part of the testing procedure to validate the candidate 2D image frame.

In some implementations, step 310 may precede step 308, and feature considerations will only be made for those frames having reliable pose data.

At 312, the method 300 includes determining one or more quality parameters of the candidate 2D image frame N. For example, a quality parameter may include a photographic characteristic of the candidate 2D image frame N, such as blur, exposure, brightness, sharpness, and hue. In one particular example, the one or more quality parameters include a level of blur and a level of exposure, Any suitable quality parameter may be determined for the candidate 2D image frame N.

In some implementations, determining the one or more quality parameters may include determining a quality score of the candidate 2D image frame N based on a combination of a plurality of values of different photographic characteristics. In some examples, different photographic characteristics may be weighted differently. In other examples, different photographic characteristics may be weighted the same. The quality score may be determined in any suitable manner. In some implementations, step 312 may precede steps 308 and/or 310, and feature considerations will only be made for those frames having sufficient quality parameters/score.

The image quality parameters may be used by one or more of the machine-learning algorithms discussed above and/or any other suitable approach to determine whether the image quality parameters satisfy the image quality thresholds. Any suitable aspects of the image quality parameters may be computer analyzed or otherwise processed as part of the testing procedure to validate the candidate 2D image frame.

At 314, the method 300 includes determining if the one or more quality parameters meet a threshold quality level. In one example, in the case of blur, the candidate 2D image frame N meets the threshold quality level if a level of blur of the candidate 2D image frame N is less than a blur threshold. In another example, in the case of exposure, the candidate 2D image frame N meets the threshold quality level if the exposure level of the candidate 2D image frame N is within an upper threshold level and a lower threshold level. In some implementations, the candidate 2D image frame N meets the threshold quality level if the candidate 2D image frame N has a quality score greater than a threshold quality score. If the one or more quality parameters meet the threshold quality level, then the method 300 moves to 316. Otherwise, the candidate 2D image frame is deemed unsuitable for 3D model generation, and the method 300 moves to 324.

At 316, if the candidate 2D image frame passes the previously discussed feature test (i.e., step 308), quality test (i.e., step 314), and satisfies any other relevant criteria (e.g., satisfactory pose information), the candidate 2D image frame is validated for inclusion in a set of 2D image frames for 3D model generation. In some implementations, validating the candidate 2D image frame includes storing the image data for the 2D image frame as well as the determined pose and quality parameters associated with the 2D image frame in a package. Further, in implementations where metadata is received with the 2D video, such metadata optionally may be stored as part of the package when the 2D image frame is validated.

At 318, the method 300 includes determining if a number of validated 2D image frames is sufficient to generate a 3model. Different 3D reconstruction systems may require different numbers, poses, and/or quality of 2D image frames to generate a 3D model, and the sufficiency test of this step may be tuned to a particular 3D reconstruction system. In some implementations, sufficiency is determined based on a minimum number of different poses and/or a degree of coverage the different poses provide. In some implementations, sufficiency is determined based on a number of features identified collectively in the set of validated 2D image frames and/or in each of a plurality of subsets of the validated 2D image frames (e.g., a subset of frames viewing a same side of the object to be modeled). Sufficiency may be based on any suitable characteristic of the validated 2D image frames and/or the physical scene. If the number of validated 2D image frames is sufficient to generate a 3D model, then the method 300 moves to 326. Otherwise, the method 300 moves to 320.

At 320, the method 300 optionally may include determining if all candidate 2D image frames of the 2D video have been analyzed. If all candidate 2D image frames of the 2D video have been analyzed, then the method 300 moves to 322. Otherwise, the method 300 moves to 324.

At 322, all candidate 2D image frames of the 2D video have been analyzed without a sufficient number of 2D image frames to generate the 3D model being validated, accordingly, the method 300 optionally may include instructing the user to acquire additional 2D video to generate the 3D model. In some implementations, instructing the user may include suggesting additional poses from which to acquired additional 2D video. In some implementations, instructing the user may include suggesting adjustments to camera settings to improve the quality of photographic characteristics of subsequently acquired 2D video. In other implementations, the method 300 optionally may include providing the user with an error message indicating that a 3D model cannot be generated from the 2D video.

At 324, the candidate 2D image frame either has been validated or the candidate 2D image frame has been deemed unsuitable for inclusion in the set of 2D image frames. Accordingly, the method 300 includes incrementing N to select the next candidate 2D image frame to be analyzed. In some implementations, the next candidate 2D image frame may be a set time (e.g., 1 second), a set number of frames (e.g., 30 frames), a set pose difference (e.g., +/−2 degree yaw/pitch/roll and/or +/−1 m x/y/z) relative the previous candidate 2D image frame, and/or a combination of any such parameters. The next candidate 2D image frame may be selected in any suitable manner.

Once the next candidate 2D image frame is selected, the candidate 2D image frame may be analyzed (e.g., steps 306-322 of the method 300 may be repeated). Moreover, candidate 2D image frames may be successively analyzed until a sufficient number of 2D image frames have been validated.

In some implementations, at 326, the method 300 optionally may include additionally processing the set of validated 2D image frames according to a multi-pass method 400 shown in FIG. 4. The method 400 may be performed any suitable number of times to supplement and/or revise the set of 2D image frames.

At 328, the method 300 includes providing the set of validated 2D image frames to a 3D reconstruction system to generate the 3D model of the physical scene. The set of validated 2D image frames optionally may be provided as a package including associated feature information, pose information, and/or other metadata. In some implementations, the 3D reconstruction system may be executed on the same computing device that selects the set of 2D image frames. In other implementations, the 3D reconstruction system may be executed by a remote computing device, such as a service computing device of a computing cloud.

FIG. 4 shows an example method 400 for refining a set of 2D image frames of a 2D video used for 3D model generation. In particular, the method 400 may be performed one or more times to increase a quality of the set, which in turn may produce a higher quality and/or more accurate 3D model. For example, the method 400 may be performed by a computing device, such as the mobile computing device 100 of FIG. 1, the computing device 202 of FIG. 2, or the computing system 500 of FIG. 5.

In some implementations, the computing device may be a cloud or service computing device, and the method 400 may be selectively performed based on a processing load of the service computing device and/or a processing load of the computing cloud. Accordingly, at 402, the method 400 optionally may include determining if processing resources are available for refining a set of 2D image frames of a 2D video. For example, processing resources may be determined to be available if a processing load of the computing device is less than a threshold processing load. An availability of processing resources may be determined in any suitable manner. If the processing resources are available, then the method 400 moves to 404. Otherwise, the method 400 returns to other operations.

At 404, the method 400 includes analysing 2D image frames of the 2D video that neighbor 2D image frames previously selected. For example, for each 2D image frame in the set, one or more 2D image frames positioned in front of and/or behind the 2D image frame in the 2D video may be analyzed to determine a number of features in the neighboring 2D image frame, a pose of the neighboring 2D image frame, and one or more quality parameters and/or a quality score of the neighboring 2D image frame. The “neighboring” frame(s) that are analysed may be any frame that is +/−X frames from a previously selected frame, where X can be any suitable integer (e.g., 1, 2, 5, 10, 15). In some implementations, different neighbors may continue to be analyzed while processing resources remain available and/or until a total quality metric for the set has been satisfied.

The data of the neighboring 2D image frames (e.g., features, pose, and image quality parameters) may be used by one or more of the machine-learning algorithms discussed above and/or any other suitable approach to determine whether such data satisfies the selection criteria. Any suitable aspects of such data may be computer analyzed or otherwise processed as part of the testing procedure to validate the neighboring 2D image frame.

At 406, the method 400 includes determining if any neighboring 2D image frame is suitable for inclusion in the set. In some implementations, a neighboring 2D image frame may be determined to be suitable for inclusion based on the neighboring 2D image frame having a greater number of features than any nearby 2D image frames that were previously selected. In some implementations, a neighboring 2D image frame may be determined to be suitable for inclusion based on the neighboring 2D image frame having less blur than any nearby 2D image frames that were previously selected. Blur is provided as an example, and any other quality parameters and/or a combination of quality parameters may be used in such a comparison. In some implementations, a neighboring 2D image frame may be determined to be suitable for inclusion in the set based on the neighboring 2D image frame having a higher quality score than any nearby 2D image frames that were previously selected. If any neighboring 2D image frame is suitable for inclusion in the set, then the method 400 moves to 408. Otherwise, the method 400 returns to other operations.

At 408, the method 400 includes adding a neighboring 2D image frame that is deemed suitable to the set. In some scenarios, new frames may be added to the set without replacing previously selected image frames—i.e., to increase total coverage. In some scenarios, a new frame may replace a previously selected frame—i.e., to improve average frame quality.

At 410, the method 400 includes providing the refined set of 2D image frames to the 3D reconstruction system to generate a 3D model of at least a portion of the physical scene. The set of validated 2D image frames optionally may be provided as a package including associated feature information, pose information, and/or other metadata.

FIG. 5 schematically shows a non-limiting implementation of a computing system 500 that can enact one or more of the methods and processes described above. Computing system 500 is shown in simplified form. Computing system 500 may take the form of one or more personal computers, server computers, tablet computers, home-entertainment computers, network computing devices, gaming devices, mobile computing devices, mobile communication devices (e.g., smart phone), virtual-reality devices, and/or other computing devices. Computing system 500 may be a non-limiting example of the mobile computing device 100 of FIG. 1, the computing device 202, the remote computing device 212, and the service computing device 220 of FIG. 2.

Computing system 500 includes a logic machine 502 and a storage machine 504. Computing system 500 may optionally include a display subsystem 506, input subsystem 508, communication subsystem 510, and/or other components not shown in FIG. 5.

Logic machine 502 includes one or more physical devices configured to execute instructions. For example, the logic machine 502 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine 502 may include one or more processors configured to execute software instructions. Additionally or alternatively, the logic machine 502 may include one or more hardware or firmware logic machines configured to execute hardware or firmware instructions. Processors of the logic machine 502 may be single-core or multi-core, and the instructions executed thereon may be configured for sequential, parallel, and/or distributed processing. Individual components of the logic machine 502 optionally may be distributed among two or more separate devices, which may be remotely located and/or configured for coordinated processing. Aspects of the logic machine 502 may be virtualized and executed by remotely accessible, networked computing devices configured in a cloud-computing configuration.

Storage machine 504 includes one or more physical devices configured to hold instructions executable by the logic machine 502 to implement the methods and processes described herein. When such methods and processes are implemented, the state of storage machine 504 may be transformed—e.g., to hold different data.

Storage machine 504 may include removable and/or built-in devices. Storage machine 504 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 504 may include volatile, nonvolatile, dynamic, static, read/write, read-only, random-access, sequential-access, location-addressable, file-addressable, and/or content-addressable devices.

It will be appreciated that storage machine 504 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 502 and storage machine 504 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 506 may be used to present a visual representation of data held by storage machine 504. This visual representation may take the form of a graphical user interface (GUI). As the herein described methods and processes change the data held by the storage machine, and thus transform the state of the storage machine, the state of display subsystem 506 may likewise be transformed to visually represent changes in the underlying data. Display subsystem 506 may include one or more display devices utilizing virtually any type of technology. Such display devices may be combined with logic machine 502 and/or storage machine 504 in a shared enclosure, or such display devices may be peripheral display devices. As a non-limiting example, display subsystem 506 may include the near-eye displays described above.

When included, input subsystem 508 may comprise or interface with one or more user-input devices such as a keyboard, mouse, touch screen, or game controller. In some implementations, the input subsystem may comprise or interface with selected natural user input (NUI) componentry. Such componentry may be integrated or peripheral, and the transduction and/or processing of input actions may be handled on- or off-board. Example NW componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 510 may be configured to communicatively couple computing system 500 with one or more other computing devices. Communication subsystem 510 may include wired and/or wireless communication devices compatible with one or more different communication protocols. As non-limiting examples, the communication subsystem may be configured for communication via a wireless telephone network, or a wired or wireless local- or wide-area network. In some implementations, the communication subsystem 510 may allow computing system 500 to send and/or receive messages to and/or from other devices via a network such as the Internet.

In an example, a method comprises receiving a two-dimensional (2D) video of a physical scene, the 2D video including a plurality of 2D image frames, for each of a plurality of candidate 2D image frames of the 2D video, computer testing the candidate 2D image frame using at least one of a feature count criteria, a pose criteria, and an image quality criteria, computer validating selected ones of the plurality of candidate 2D image frames that satisfy the feature count criteria, the pose criteria, and the image quality criteria, and providing a set of validated 2D image frames to a three-dimensional (3D) reconstruction system to generate a 3D model of at least a portion of the physical scene. In this example and/or other examples, computer testing may include, for each candidate 2D image frame, applying a feature identification algorithm to the candidate 2D image frame to identify a number of features of the candidate 2D image frame. In this example and/or other examples, computer testing includes for each candidate image frame, determining a pose in six degrees of freedom in the physical scene of a device that captured the 2D image frame when the 2D image frame was captured by the device. In this example and/or other examples, computer testing includes for each candidate image frame, determining one or more image quality parameters of the 2D image frame including one or more of sharpness, exposure level, and blur. In this example and/or other examples, the feature count criteria may include a threshold number of features, the pose criteria may include a pose reliability threshold, the image quality criteria may include a threshold quality level of the one or more image quality parameters, and computer validating may include if the number of identified features of the candidate 2D image frame is greater than the threshold number of features, if the pose of the candidate 2D image frame meets the pose reliability threshold, and if at least one of the one or more image quality parameters of the 2D image frame is greater than the threshold quality level, then validating the candidate 2D image frame for inclusion in the set. In this example and/or other examples, the 2D video may be received from a device as the device is capturing the 2D video. In this example and/or other examples, the 2D video may be previously recorded. In this example and/or other examples, the method may further comprise instructing a user to acquire additional 2D video to generate the 3D model based on the set of validated 2D image frames being insufficient to generate the 3D model. In this example and/or other examples, instructing may include suggesting additional poses from which to acquire additional 2D video. In this example and/or other examples, instructing may include suggesting adjustments to camera settings to improve the quality of one or more image quality parameters of subsequently acquired 2D video. In this example and/or other examples, the method may further comprise computer refining the set of validated 2D image frames by adding one or more previously unvalidated 2D image frames of the 2D video to the set, wherein the one or more previously unvalidated 2D image frames neighbor a validated 2D image frame previously selected for inclusion in the set. In this example and/or other examples, the one or more previously unvalidated 2D image frames may include a 2D image frame that meets the feature count criteria, the pose criteria, and the image quality criteria better than other neighboring validated 2D image frames that were previously selected for inclusion in the set.

In an example, a computing device comprises a logic machine, and a storage machine holding instructions executable by the logic machine to receive a two-dimensional (2D) video of a physical scene, the 2D video including a plurality of 2D image frames, for each of a plurality of candidate 2D image frames of the 2D video, test the candidate 2D image frame using at least one of a feature count criteria, a pose criteria, and an image quality criteria, validate selected ones of the plurality of candidate 2D image frames that satisfy the feature count criteria, the pose criteria, and the image quality criteria, and provide a set of validated 2D image frames to a three-dimensional (3D) reconstruction system to generate a 3D model of at least a portion of the physical scene. In this example and/or other examples, testing may include, for each candidate 2D image frame applying a feature identification algorithm to the candidate 2D image frame to identify a number of features of the candidate 2D image frame, determining a pose in six degrees of freedom in the physical scene of a device that captured the 2D image frame when the 2D image frame was captured by the device, and determining one or more image quality parameters of the 2D image frame including one or more of sharpness, exposure level, and blur. In this example and/or other examples, the feature count criteria may include a threshold number of features, the pose criteria may include a pose reliability threshold, the image quality criteria may include a threshold quality level of the one or more image quality parameters, and validating may include if a number of identified features of the candidate 2D image frame is greater than the threshold number of features, if the pose of the candidate 2D image frame meets the pose reliability threshold, and if at least one of the one or more image quality parameters of the 2D image frame is greater than the threshold quality level, then validating the candidate 2D image frame for inclusion in the set. In this example and/or other examples, the storage machine may further hold instructions executable by the logic machine to instruct a user to acquire additional 2D video to generate the 3D model based on the set of validated 2D image frames being insufficient to generate the 3D model. In this example and/or other examples, the storage machine may further hold instructions executable by the logic machine to refine the set of validated 2D image frames by adding one or more previously unvalidated 2D image frames of the 2D video to the set, the one or more previously unvalidated 2D image frames may neighbor a validated 2D image frame previously selected for inclusion in the set.

In an example, a method comprises receiving a two-dimensional (2D) video of a physical scene, the 2D video including a plurality of 2D image frames, for each of a plurality of candidate 2D image frames of the 2D video, computer testing the candidate 2D image frame using at least one of a feature count criteria, a pose criteria, and an image quality criteria, computer validating selected ones of the plurality of candidate 2D image frames that satisfy the feature count criteria, the pose criteria, and the image quality criteria, providing a set of validated 2D image frames to a three-dimensional (3D) reconstruction system to generate a 3D model of at least a portion of the physical scene, and computer refining the set of validated 2D image frames by adding one or more previously unvalidated 2D image frames of the 2D video to the set, wherein the one or more previously unvalidated 2D image frames neighbor a validated 2D image frame previously selected for inclusion in the set. In this example and/or other examples, the one or more previously unvalidated 2D image frames may include a 2D image frame that meets the feature count criteria, the pose criteria, and the image quality criteria better than other neighboring validated 2D image frames that were previously selected for inclusion in the set. In this example and/or other examples, the method may further comprise instructing a user to acquire additional 2D video to generate the 3D model based on the set of validated 2D image frames being insufficient to generate the 3D model, wherein instructing includes one or more of suggesting additional poses from which to acquire additional 2D video and suggesting adjustments to camera settings to improve the quality of one or more image quality parameters of subsequently acquired 2D video.

It will be understood that the configurations and/or approaches described herein are exemplary in nature, and that these specific implementations or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method, comprising:
receiving a two-dimensional (2D) video of a physical scene, the 2D video including a plurality of 2D image frames;
for each of a plurality of candidate 2D image frames of the 2D video, computer testing the candidate 2D image frame using at least one of a feature count criteria, a pose criteria, and an image quality criteria;
computer validating selected ones of the plurality of candidate 2D image frames that satisfy the feature count criteria, the pose criteria, and the image quality criteria; and
providing a set of validated 2D image frames to a three-dimensional (3D) reconstruction system to generate a 3D model of at least a portion of the physical scene.

2. The method of claim 1, wherein computer testing includes, for each candidate 2D image frame:
applying a feature identification algorithm to the candidate 2D image frame to identify a number of features of the candidate 2D image frame.

3. The method of claim 2, wherein computer testing includes for each candidate image frame:
determining a pose in six degrees of freedom in the physical scene of a device that captured the 2D image frame when the 2D image frame was captured by the device.

4. The method of claim 3, wherein computer testing includes for each candidate image frame:
determining one or more image quality parameters of the 2D image frame including one or more of sharpness, exposure level, and blur.

5. The method of claim 4, wherein the feature count criteria includes a threshold number of features, wherein the pose criteria includes a pose reliability threshold, wherein the image quality criteria includes a threshold quality level of the one or more image quality parameters, and wherein computer validating includes:
if the number of identified features of the candidate 2D image frame is greater than the threshold number of features, if the pose of the candidate 2D image frame meets the pose reliability threshold, and if at least one of the one or more image quality parameters of the 2D image frame is greater than the threshold quality level, then validating the candidate 2D image frame for inclusion in the set.

6. The method of claim 1, wherein the 2D video is received from a device as the device is capturing the 2D video.

7. The method of claim 1, wherein the 2D video is previously recorded.

8. The method of claim 1, further comprising:
instructing a user to acquire additional 2D video to generate the 3D model based on the set of validated 2D image frames being insufficient to generate the 3D model.

9. The method of claim 8, wherein instructing includes suggesting additional poses from which to acquire additional 2D video.

10. The method of claim 8, wherein instructing includes suggesting adjustments to camera settings to improve the quality of one or more image quality parameters of subsequently acquired 2D video.

11. The method of claim 1, further comprising:
computer refining the set of validated 2D image frames by adding one or more previously unvalidated 2D image frames of the 2D video to the set, wherein the one or more previously unvalidated 2D image frames neighbor a validated 2D image frame previously selected for inclusion in the set.

12. The method of claim 11, wherein the one or more previously unvalidated 2D image frames include a 2D image frame that meets the feature count criteria, the pose criteria, and the image quality criteria better than other neighboring validated 2D image frames that were previously selected for inclusion in the set.

13. A computing device comprising:
a logic machine; and
a storage machine holding instructions executable by the logic machine to:
receive a two-dimensional (2D) video of a physical scene, the 2D video including a plurality of 2D image frames;
for each of a plurality of candidate 2D image frames of the 2D video, test the candidate 2D image frame using at least one of a feature count criteria, a pose criteria, and an image quality criteria;
validate selected ones of the plurality of candidate 2D image frames that satisfy the feature count criteria, the pose criteria, and the image quality criteria; and
provide a set of validated 2D image frames to a three-dimensional (3D) reconstruction system to generate a 3D model of at least a portion of the physical scene.

14. The computing device of claim 13, wherein testing includes, for each candidate 2D image frame:
applying a feature identification algorithm to the candidate 2D image frame to identify a number of features of the candidate 2D image frame,
determining a pose in six degrees of freedom in the physical scene of a device that captured the 2D image frame when the 2D image frame was captured by the device, and
determining one or more image quality parameters of the 2D image frame including one or more of sharpness, exposure level, and blur.

15. The computing device of claim 14, wherein the feature count criteria includes a threshold number of features, wherein the pose criteria includes a pose reliability threshold, wherein the image quality criteria includes a threshold quality level of the one or more image quality parameters, and wherein validating includes:
if a number of identified features of the candidate 2D image frame is greater than the threshold number of features, if the pose of the candidate 2D image frame meets the pose reliability threshold, and if at least one of the one or more image quality parameters of the 2D image frame is greater than the threshold quality level, then validating the candidate 2D image frame for inclusion in the set.

16. The computing device of claim 13, wherein the storage machine further hold instructions executable by the logic machine to:
instruct a user to acquire additional 2D video to generate the 3D model based on the set of validated 2D image frames being insufficient to generate the 3D model.

17. The computing device of claim 13, wherein the storage machine further hold instructions executable by the logic machine to:
refine the set of validated 2D image frames by adding one or more previously unvalidated 2D image frames of the 2D video to the set, wherein the one or more previously unvalidated 2D image frames neighbor a validated 2D image frame previously selected for inclusion in the set.

18. A method comprising:
receiving a two-dimensional (2D) video of a physical scene, the 2D video including a plurality of 2D image frames;
for each of a plurality of candidate 2D image frames of the 2D video, computer testing the candidate 2D image frame using at least one of a feature count criteria, a pose criteria, and an image quality criteria;
computer validating selected ones of the plurality of candidate 2D image frames that satisfy the feature count criteria, the pose criteria, and the image quality criteria;
providing a set of validated 2D image frames to a three-dimensional (3D) reconstruction system to generate a 3D model of at least a portion of the physical scene; and
computer refining the set of validated 2D image frames by adding one or more previously unvalidated 2D image frames of the 2D video to the set, wherein the one or more previously unvalidated 2D image frames neighbor a validated 2D image frame previously selected for inclusion in the set.

19. The method of claim 18, wherein the one or more previously unvalidated 2D image frames include a 2D image frame that meets the feature count criteria, the pose criteria, and the image quality criteria better than other neighboring validated 2D image frames that were previously selected for inclusion in the set.

20. The method of claim 18, further comprising:
instructing a user to acquire additional 2D video to generate the 3D model based on the set of validated 2D image frames being insufficient to generate the 3D model, wherein instructing includes one or more of suggesting additional poses from which to acquire additional 2D video and suggesting adjustments to camera settings to improve the quality of one or more image quality parameters of subsequently acquired 2D video.
